(19) United States
(12) Patent Application Publication
(10) Pub. No.: US 2025/0058268 A1
(43) Pub. Date: Feb. 20, 2025

(54) DEVICE FOR ABSORBING WATER FROM A GAS, AND COMPUTER IMPLEMENTED METHOD FOR IMPROVING OPERATION OF SUCH A DEVICE

(71) Applicant: DRUPPS AB, UPPSALA (SE)

(72) Inventors: Fredrik EDSTRÖM, UPPSALA (SE); Per DAHLBÄCK, VÄNGE (SE); Johanna UNOSSON, UPPSALA (SE)

(21) Appl. No.: 18/720,765

(22) PCT Filed: Dec. 19, 2022
(86) PCT No.: PCT/SE2022/051202

§ 371 Date: Jun. 17, 2024

(30) Foreign Application Priority Data
Dec. 21, 2021 (SE) 2151579-6

(51) Int. Cl. B01D 53/14; B01D 53/18; B01D 53/26

(52) U.S. Cl. CPC B01D 53/1412; B01D 53/1425; B01D 53/18; B01D 53/263; B01D 2257/80

(57) ABSTRACT

The present invention relates to a device for absorbing water from a gas and to a computer implemented method for improving operation of such a device. The method comprises
i) receiving, in processing circuitry, an first input signal comprising a parameter indicative of a pH value of output water,
ii) comparing, using the processing circuitry, the parameter to a first criterion indicative of an allowed pH value or interval of the parameter, and
iii) if the first criterion is not fulfilled, determining, using the processing circuitry, that a pH correction of the liquid desiccant is needed based on at least the comparison of step ii).

### TECHNICAL FIELD

The present invention relates to devices and methods for absorbing water from a gas, in particular from an airstream.

### BACKGROUND

Devices for absorbing water from a gas are known within the art and are highly beneficial in capturing moisture in air to provide clean water for drinking and other purposes. In particular in hot climates where supplies of fresh water are scarce, such devices are able to provide water of high quality in a cost-efficient and energy-efficient way.

However, during operation of water absorbing devices their performance tends to decrease over time so that the absorption of moisture from the gas is rendered less efficient. There may also be problems affecting the quality of the water produced to render it less suitable for drinking.

At present, there is limited knowledge of these problems and also of possible ways to alleviate them. There is therefore a need for further developments within this field to ensure a high-quality operation of such devices over time as well as ensuring a consistent high quality of the water produced.

### SUMMARY

The object of the present invention is to eliminate or at least to minimize the problems discussed above. This is achieved by a device for absorbing water from a gas, and a computer implemented method for improving operation of a device for absorbing water from a gas, according to the appended independent claims.

The device according to the invention comprises
a water absorption unit for absorbing water from a gas flow using a liquid desiccant,
a liquid desiccant container and
a liquid desiccant regeneration unit,
wherein the water absorption unit and the liquid desiccant container are operatively connected in a loop such that liquid desiccant is able to flow from the liquid desiccant container to the water absorption unit and again to the liquid desiccant container, and wherein the liquid desiccant regeneration unit is operatively connected to the liquid desiccant container or to the loop for removing and regenerating liquid desiccant and returning regenerated liquid desiccant to the liquid desiccant container or to the loop.

The liquid desiccant regeneration unit of the device further comprises a water outlet for output water removed from the liquid desiccant during regeneration, and the device further comprises a pH adjustment unit that is operatively connected to the liquid desiccant container or to the loop for supplying a pH adjustment substance to the liquid desiccant.

Furthermore, the device comprises processing circuitry configured to:
i) receive a first input signal comprising a parameter indicative of a pH value of output water,
ii) comparing the parameter to a first criterion indicative of an allowed value or interval of the parameter, and
iii) if the first criterion is not fulfilled, determining that a pH correction of the liquid desiccant is needed based on at least the comparison of step ii).

By the processing circuitry being configured to determine if the pH of the liquid desiccant should be corrected, it is possible to maintain the pH of the liquid desiccant at a desired level or in a desired range. This serves to prevent contamination of the output water and at the same time enables efficient operation of the device over time so that water absorption from the gas can take place as desired.

Suitably, the processing circuitry is also configured to generate, based on the determined pH correction, a first control signal indicative of an amount of adjustment substance to be supplied to the liquid desiccant to achieve the determined pH correction, and optionally also causing the pH adjustment unit to supply the indicated amount of adjustment substance to the liquid desiccant. Thereby, the device is able to correct the pH of the liquid desiccant in an efficient and convenient manner without causing interruption to the operation of the device.

The pH adjustment unit may be a container for holding the pH adjustment substance, said container being connected to the liquid desiccant container or to the loop so that a controlled amount of the pH adjustment substance can be supplied to the liquid desiccant. Thereby, a supply of pH adjustment substance may be already present in the device, so that the correction of the pH of the liquid desiccant can take place in an easy and efficient way.

Alternatively, the device may comprise an output device, and the processing circuitry may be configured to generate a first control signal based on the determined pH correction, wherein the first control signal may also be determined to be indicative of an amount of adjustment substance to be supplied to the liquid desiccant to achieve the determined pH correction. The first control signal may further be configured to cause the output device to display information prompting a user to correct the PH value of the liquid desiccant such that the determined PH correction is achieved. Thereby, a correction may be applied manually by the pH correction substance being entered into the device by a user in response to prompting by the device. In other embodiments, a pre-determined amount of pH adjustment substance may instead be supplied.

The pH adjustment unit may then comprise a scalable opening in the liquid desiccant container or in the loop, and the scalable opening may be configured to receive the pH adjustment substance through manual input by a user. This is a very simple and convenient way of adding the pH adjustment substance.

Suitably, the processing circuitry is configured to repeatedly perform steps i)-iii). Thereby, the pH of the output water may be monitored, and pH corrections performed on the liquid desiccant when the first criterion is no longer fulfilled.

The device may also comprise an input device with a user interface for receiving an input comprising the parameter, wherein the input device is configured to transmit the first input signal to the processing circuitry. Thereby, the parameter may be given as input by a user based on a manual detection or using another device or a sensor not forming part of the device according to the invention. This is advantageous in allowing for user input in combination with or instead of detection or measurements performed within the device.

Suitably, the device comprises at least one sensor configured to detect the parameter. Thereby, the parameter may be detected, or a value of the parameter may be detected or measured, in a convenient and reliable way from within the device itself.

In some embodiments, the sensor is a conductivity sensor for detecting a conductivity of water in the liquid desiccant regeneration unit or in the output water. The conductivity of the water may indicate the presence of a substance that has been transferred to the output water from the liquid desiccant in the regeneration. Suitably, the device also comprises a temperature sensor configured to detect a temperature of water in the liquid desiccant regeneration unit or in the output water. The processing circuitry may then further be configured to determine the pH correction based also on the detected temperature. This ensures an increased accuracy when determining if the pH should be corrected based on the conductivity in the output water. By correcting the pH of the liquid desiccant, the risk of transferring a substance affecting the conductivity to the output water is significantly decreased or even eliminated, thus increasing the quality of the output water.

In some embodiments, the device may comprise a pH measuring device that is operatively connected to the liquid desiccant container or to the loop for receiving a quantity of liquid desiccant. The sensor is then configured to measure the parameter in the pH measuring device. Thereby, the pH of the liquid desiccant may be measured directly, thereby indicating the presence of a substance that is transferred to the output water and that would affect the quality of the water.

In some embodiments, the at least one sensor is configured to detect a substance in the gas flow downstream of the water absorption unit. Thereby, a substance affecting the pH of the liquid desiccant that is transferred to the gas flow as it passes the water absorption unit may be detected, and this in turn indicates that the same substance is also transferred to the output water so that the quality of the water is negatively affected.

The first criterion may comprise a threshold value or an interval. Thereby, a desired value or range for the parameter in the output water may be selected so that the processing circuitry is configured to determine that a correction is needed if the detected parameter is above or below the desired value or outside of the desired range.

Also, in some embodiments the first input signal comprises a value of the parameter obtained at a first time instance, t1, and the processing circuitry is configured to:
receive a second input signal comprising a second value of the parameter obtained at a second time instance, t2, that differs from the first time instance, t1,
determine a rate of change of the value of the parameter based on at least the first input signal and the second input signal,
comparing the rate of change of the value of the parameter to a second criterion indicative of an allowed rate of change of the value of the parameter, and
if the first criterion is fulfilled and the second criterion is not fulfilled, determine the pH correction based on at least the determined rate of change of the parameter and the allowed rate of change of the parameter; or
if the first criterion is not fulfilled and the second criterion is not fulfilled, determine the pH correction based on at least the comparison of step ii), the determined rate of change of the parameter and the allowed rate of change of the parameter.

Thereby, changes in the parameter may be used in combination with the parameter fulfilling the first criterion when determining if a correction is needed. This is particularly useful where the parameter fulfils the first criterion but where the absolute value of the rate of change is high, indicating that the parameter quickly changes. Corrections may then be performed to ensure that the parameter continues to fulfil the first criterion.

The present invention also relates to a computer implemented method for improving operation of a water absorbing device, the device comprising
a water absorption unit for absorbing water from a gas flow using a liquid desiccant,
a liquid desiccant container and
a liquid desiccant regeneration unit,
   wherein the water absorption unit and the liquid desiccant container are operatively connected in a loop such that liquid desiccant is able to flow from the liquid desiccant container to the water absorption unit and again to the liquid desiccant container, and wherein the liquid desiccant regeneration unit is operatively connected to the liquid desiccant container or to the loop for removing and regenerating liquid desiccant and returning regenerated liquid desiccant to the liquid desiccant container or to the loop,
   and the liquid desiccant regeneration unit further comprising a water outlet for output water removed from the liquid desiccant during regeneration,
   wherein the device also comprises a pH adjustment unit that is operatively connected to the liquid desiccant container or to the loop for supplying a pH adjustment substance to the liquid desiccant,
   wherein the device further comprises processing circuitry, and
   wherein the method comprises the steps of:
i) receiving, in processing circuitry, an first input signal comprising a parameter indicative of a pH value of output water,
ii) comparing, using the processing circuitry, the parameter to a first criterion indicative of an allowed value or interval of the parameter, and
iii) if the first criterion is not fulfilled, determining, using the processing circuitry, that a pH correction of the liquid desiccant is needed based on at least the comparison of step ii).

Furthermore, the method may also comprise:
generate, based on the determined pH correction, a first control signal indicative of an amount of adjustment substance to be supplied to the liquid desiccant to achieve the determined pH correction,
optionally also causing the pH adjustment unit to supply the indicated amount of adjustment substance to the liquid desiccant.

In some embodiments, the method may further comprise generating, using the processing circuitry, a first control signal based on the determined pH correction, wherein the first control signal may also be determined to be indicative of an amount of adjustment substance to be supplied to the liquid desiccant to achieve the determined pH correction,
transmitting the first control signal to an output device, and
prompting a user, by displaying information in the output device, to correct the PH value of the liquid desiccant such that the determined PH correction is achieved.

The method may also comprise repeating steps i)-iii).

Suitably, the method also comprises
detecting, by a sensor, the at least one parameter
transmitting an first input signal comprising the at least one parameter to the processing circuitry.

In some embodiments, the parameter is a conductivity of water in the liquid desiccant regeneration unit or of the output water.

Also, the method may comprise
detecting, by a second sensor, a temperature of the water
determining, by the processing circuitry, the pH correction based also on the detected temperature.

In some embodiments, the parameter is a pH of the liquid desiccant.

In other embodiments, the parameter is a presence of a substance in the gas flow downstream of the water absorption unit.

The first criterion may comprise a threshold value or an interval.

Suitably, the first input signal comprises a value of the parameter obtained at a first time instance, t1, and the method may further comprise:
receiving, in the processing circuitry, a second input signal comprising a value of the parameter obtained at a second time instance, t2, that differs from the first time instance, t1,
determining, using the processing circuitry, a rate of change of the value of the parameter based on at least the first input signal and the second input signal,
comparing, using the processing circuitry, the rate of change of the value of the parameter to a second criterion indicative of an allowed rate of change of the parameter, and
if the first criterion is fulfilled and the second criterion is not fulfilled, determine the pH correction based on at least the determined rate of change of the parameter and the allowed rate of change of the parameter; or
if the first criterion is not fulfilled and the second criterion is not fulfilled, determine the pH correction based on at least the comparison of step ii), the determined rate of change of the parameter and the allowed rate of change of the parameter.

Many additional benefits and advantages of the present invention will be readily understood by the skilled person in view of the detailed description below.

### DRAWINGS

The invention will now be described in more detail with reference to the appended drawings, wherein

FIG. 1 discloses schematically a device for absorbing water from a gas according to a first embodiment of the invention;

FIG. 2 discloses schematically a device according to a second embodiment of the invention;

FIG. 3 is a flow chart illustrating a method for improving operation of a device for absorbing water from a gas according to a first method embodiment of the invention;

FIG. 4 is a flow chart illustrating the method according to a second method embodiment of the invention;

FIG. 5 is a flow chart illustrating the method according to a third method embodiment where two sensors are used;

FIG. 6 is a flow chart illustrating the method according to method embodiments where the parameter is detected by a sensor or given by an input device;

FIG. 7 is a flow chart illustrating the method according to a fourth method embodiment, and

FIG. 8 discloses schematically communication between components of the device according to the invention.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

Devices for absorbing water from a gas are well-known within the art, for instance from PCT/SE2020/050107 and PCT/SE2017/050726. In general, such devices operate by allowing a gas stream (typically air) to flow through an absorbing unit (typically comprising a pad and a fan for providing a gas flow through the pad, although the absorbing device may alternatively comprise other components than a pad as long as the liquid desiccant can be brought into contact with the gas flow over a large surface area). In the absorbing unit, the gas stream is brought into contact with a liquid desiccant such that moisture in the gas stream can be absorbed by and stored in the liquid desiccant and thus brought into the device. The gas stream leaving the absorbing unit has a lower moisture content than when entering, while the water content in the liquid desiccant is gradually increased during operation of the device. When desired, the liquid desiccant is regenerated to release the captured water. This typically takes place through boiling the liquid desiccant and releasing the water as water vapor before condensing and removing the condensed water from the device. Other ways of regenerating the liquid desiccant are also known, and the substance used as liquid desiccant can be selected from a number of suitable substances. In the following, some examples of liquid desiccants will be mentioned in the description of the present invention.

The present invention will now be described in more detail with reference to the Figures. System architecture

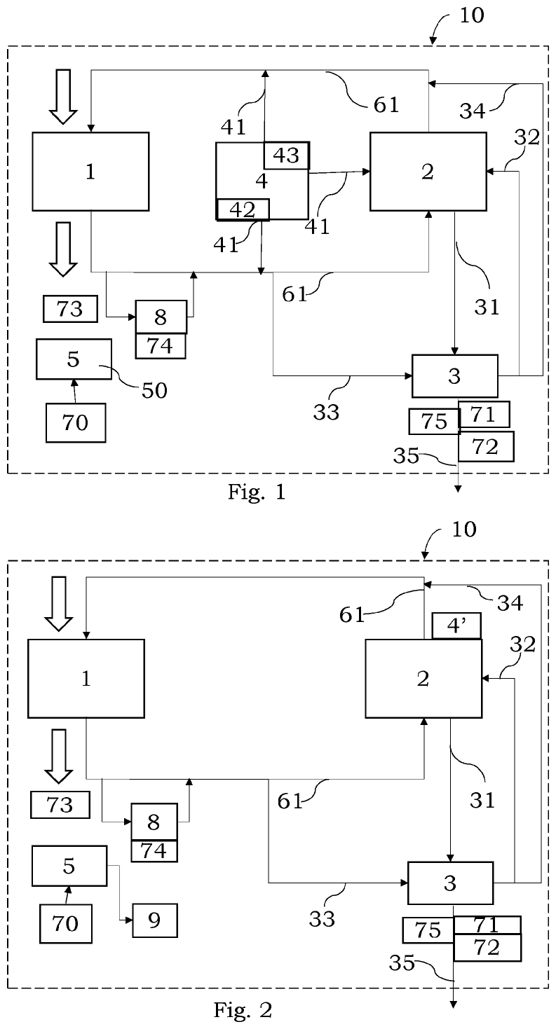

The device for absorbing water from a gas will now be described with reference to FIG. 1-2. FIG. 1 discloses a first embodiment of the device 10 where a pH adjustment unit 4 is provided as a separate component operatively connected to a liquid desiccant container 2 or a loop 61 in which liquid desiccant flows. FIG. 2 discloses a second embodiment of the device 10′ where the pH adjustment unit 4′ is instead provided as a sealable opening in the liquid desiccant container 2 and where an output device 9 is provided for prompting a user to manually insert a pH adjustment substance into the liquid desiccant container 2 through the opening provided by the pH adjustment unit 4′.

In many aspects, the first embodiment and the second embodiment are similar or identical, and components that are included in both embodiments and that perform identical or similar functions are denoted by the same reference numerals. It is in particular to be noted that features from each of the embodiments described herein may freely be combined with any other embodiment as long as such a combination is not explicitly stated as unsuitable or undesirable.

The term operatively connected is used herein to signify that one component is connected to another in such a way that a signal, a movement or a force can be transferred from one to the other, or that a substance may be transported from one to the other. Similarly, the term communicatively connected is to be understood that one component is connected to another in such a way that a signal can be transmitted from one and received by the other.

In the first embodiment of FIG. 1, the device 10 comprises a water absorption unit 1 and the liquid desiccant container 2 that are connected in the loop 61 so that liquid desiccant can flow in the loop 61 from the liquid desiccant container 2 and to the water absorption unit 1 before returning to the liquid desiccant container 2. The loop 61 may comprise at least one conduit or pipe but may alternatively comprise a plurality of conduits or pipes and may also comprise at least one component arranged in the loop so that liquid desiccant is able to flow in the loop through said at least one component. Such components may comprise at least one pump or filter, and also optionally at least one sensor for detecting or measuring a property of the liquid desiccant.

The water absorption unit 1 suitably comprises a cooling pad and/or an evaporator pad. Such pads have a large surface area on which the liquid desiccant is applied through spraying or the like, and a gas flow (denoted by arrows to and from the water absorption unit 1) is allowed to flow through the pad and thereby contact the liquid desiccant. Examples of suitable pads include CeLPad 0760 and CeLPad 0790 from Hutek, but there are also other types of pad that are suitable for use in the device 10 of the present invention. The gas in the gas flow is typically air, but may in some embodiments alternatively be other gases as well.

After passing through the water absorption unit 1, the liquid desiccant is transported to the liquid desiccant container 2 and by supplying a continuous flow of liquid desiccant to the water absorption unit 1, moisture is continuously absorbed from the gas flow. When the amount of water present in the liquid desiccant reaches a predetermined value, regeneration of the liquid desiccant is performed by transporting liquid desiccant to a regeneration unit 3 from the liquid desiccant container 2 in a first regeneration conduit 31 or from the loop 61 in a second regeneration conduit 33. In some embodiments, it is advantageous to use the first regeneration conduit 31 since this ensures a remaining supply that is circulated in the loop 61 from the liquid desiccant container 2 to the water absorption unit 1 and back again, but in other embodiments liquid desiccant may instead be removed from the loop 61 directly and may also be returned to the loop 61 after regeneration.

In some embodiments, regeneration takes place at regular intervals or even continuously, using a smaller quantity of the liquid desiccant for regeneration, whereas in other embodiments a larger quantity or even all of the liquid desiccant may be regenerated at the same time. In such embodiments, operation of the device 10 may need to be interrupted for a short time to accommodate for the removal of the liquid desiccant.

In the regeneration unit 3, the liquid desiccant is thus regenerated in a manner known in the art, typically through boiling the liquid desiccant to allow the captured water to vaporize and be collected after condensation. The water is then removed from the regeneration unit 3 through a water outlet 35. In some embodiments, removal of water takes place continuously while regeneration takes place, but in other embodiments output water may instead be collected in an internal tank or container in the regeneration unit 3 before being evacuated through the water outlet 35.

The term output water is used herein to denote water that is removed from the liquid desiccant through regeneration in the regeneration unit 3, regardless of whether it has been removed through the water outlet 35 or is collected in the internal tank or container.

After regeneration, regenerated liquid desiccant is returned to the liquid desiccant container 2 through a first return conduit 32 or to the loop 61 through a second return conduit 34. In some embodiments, liquid desiccant may be transported to the liquid regeneration unit 3 through one or both of the first regeneration conduit 31 and the second regeneration conduit 33 and be returned through one or both of the first return conduit 32 and the second return conduit 34.

The device 10 also comprises the pH adjustment unit 4 that is operatively connected to the liquid desiccant container 2 or to the loop 61 upstream or downstream of the liquid desiccant container 2 through at least one adjustment substance conduit 41. Inside the pH adjustment unit 4 are suitably a container 42 holding a pH adjustment substance and a controlled release mechanism 43 such as a valve that acts to release a desired amount of the pH adjustment substance to the liquid desiccant.

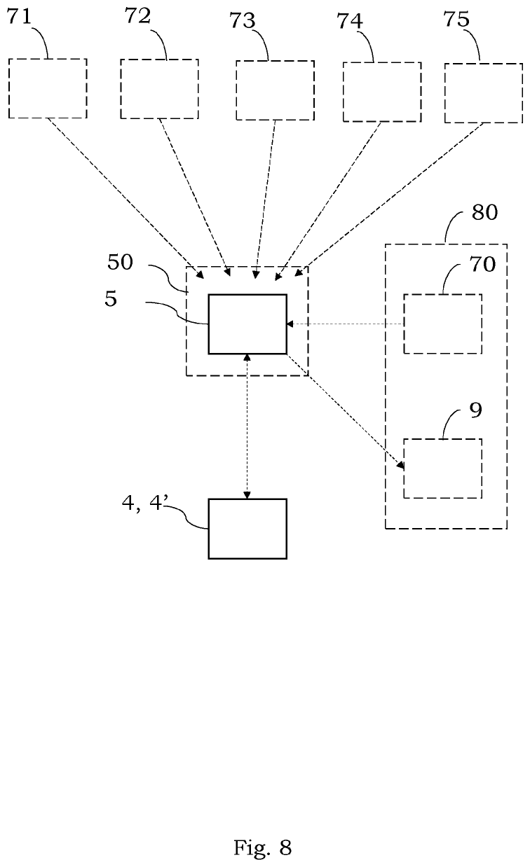

In the device 10 there is also processing circuitry 5 that may be held in a control unit 50, which may be incorporated in the device 10 or communicatively connected to the device 10. Alternatively, the processing circuitry 5 may be housed in another component of the device 10 or be distributed in the device 10. For simplicity, the processing circuitry 5 is shown in the drawings as comprised in a control unit 50. The processing circuitry 5 is suitably operatively and/or communicatively connected to other parts of the device 10 to be able to receive signals and/or transmit signals to them, as indicated by the arrows in FIG. 8. The connection may be wireless, using wires, or a combination.

The processing circuitry 5 is configured to receive an first input signal comprising a parameter that is indicative of a pH value of the output water. The signal may be entered manually into an input device 70 operatively and/or communicatively connected to the processing circuitry 5, and the input device 70 then comprises a user interface where a user may enter the parameter.

Alternatively, the parameter may be detected by at least one sensor 71, 72, 73, 74, 75 provided in the device 10 or in connection with the device 10. These may include a conductivity sensor 71 configured to detect a conductivity of the output water, preferably in combination with a temperature sensor 72 for detecting the temperature of the output water. At least the conductivity but preferably also the temperature may then be used as input by the processing circuitry 5 to determine if the pH of the liquid desiccant should be corrected.

Alternatively, or in combination with the conductivity sensor, the device 10 may comprise a gas flow sensor 73 configured to detect a substance in the gas flow downstream of the water absorbing unit 1. The presence of the substance, that may typically be an acid, in the gas flow indicates that the same substance is also present in both the liquid desiccant and in the output water.

Another alternative is that the device 10 comprises a pH measuring device 8 that is arranged in connection with the loop 61 but that may alternatively be arranged in connection with the liquid desiccant container 2. The pH measuring device 8 is configured to receive a quantity of liquid desiccant from the loop 61 or from the liquid desiccant container 2 and a pH sensor 74 is provided to detect a pH of the liquid desiccant in the measuring device. Typically, the liquid desiccant should be diluted before the pH can be detected, and the measuring device may be configured to supply a dilution liquid for this purpose. Alternatively, a user may supply the dilution liquid before the pH sensor 74 detects the pH of the liquid desiccant.

Yet another alternative is that the device 10 comprises a pH sensor 75 that is configured to detect pH of the output water. The pH sensor 75 may be configured to detect the pH in output water inside the liquid desiccant regeneration unit 3, in the output from the liquid desiccant regeneration unit 3 or in any other conduit or container where output water is transported or stored.

Embodiments where one or more of these sensors 71, 72, 73, 74, 75 are used will be described in more detail below where the inventive method is disclosed in detail.

In the first embodiment, the processing circuitry 5 is operatively and/or communicatively connected at least to one of the sensors 71, 72, 73, 74, 75 and/or the input device 70, and to the pH adjustment unit 4 so that the controlled release mechanism 43 can be operated to release the pH adjustment substance when the processing circuitry 5 has determined that a correction is needed. Suitably, the processing circuitry 5 is also operatively and/or communicatively connected to other components of the device 10 and indeed in some embodiments the processing circuitry 5 may also be configured to control operation of the device 10 in its entirety and to monitor a state and/or operation of components included in the device 10. The communicative connection between the processing circuitry 5 and the pH adjustment unit 4, as well as optionally between the processing circuitry 5 and any or all of the sensors 71, 72, 73, 74, 75 and/or the input device 70, is illustrated in FIG. 8.

FIG. 2 discloses the second embodiment of the device 10′ that differs from the first embodiment mainly in the pH adjustment unit 4 being provided comprising a scalable opening in the liquid desiccant container 2 and in the output device 9. In the second embodiment, other components and function of the device 10′ are similar or identical to the device 10 of the first embodiment described above.

In the second embodiment, the device 10′ is configured to prompt a user to perform the needed correction by displaying information in the output device 9. This information may be in the form of text or image or both or may alternatively comprise light or sound such as a lamp being lit or flashing when correction is needed, or an alarm signal being sounded. The user can then perform the correction manually by opening the scalable opening of the pH adjustment unit 4′ to gain access to the liquid desiccant container 2 and then inserting the pH adjustment substance into the liquid desiccant container directly. In some embodiments, the input device 70 and the output device 9 may be integrated into a single input/output device 80, comprising a user interface configured to both display information to indicate information that correction is needed and/or prompt a user to perform correction, as well as be configured to receive user input as described herein.

FIG. 8 discloses the processing circuitry 5 and the pH adjustment section 4, 4′ that are operatively or communicatively connected to each other. Also shown are optional features according to various embodiments of the invention and how these components may communicate with each other. Thus, the processing circuitry 5 may be comprised in the control unit 50 or controller 50 and be configured to receive signals from one or more sensors 71, 72, 73, 74, 75 and also to receive signals from the input device 70 and to transmit signals to the output device 9. The input device 70 and output device 9 may be comprised in the single input/output device 80.

### Method Embodiments

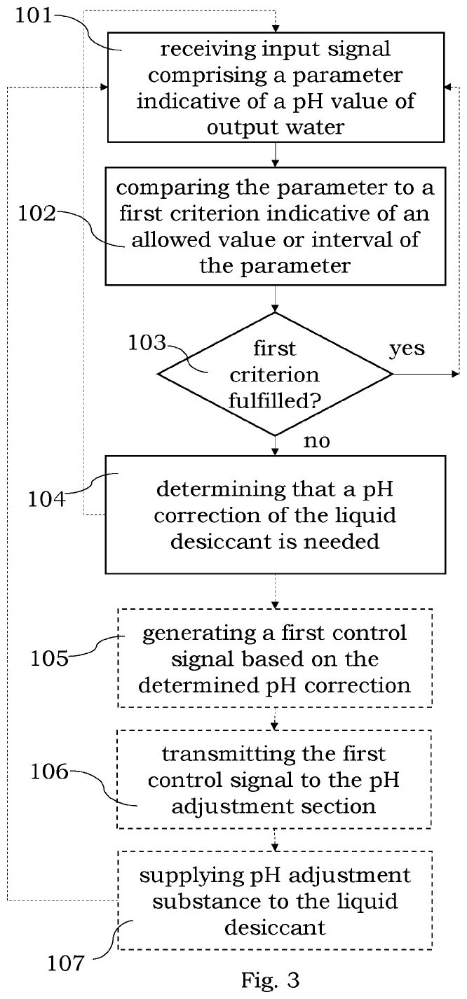

The inventive computer implemented method will now be described with reference to FIG. 3 onwards. In FIG. 3-7, optional steps are disclosed in dashed boxes.

In all method embodiments, the method comprises in step 101 receiving, in the processing circuitry 5, an first input signal comprising a parameter indicative of a pH value of output water in the device 10. The parameter may be a conductivity of the output water itself, a pH of the liquid desiccant, the presence of a substance in the gas that has passed through the water absorbing unit 1, or a parameter received in an input device having a user interface for manual input. Each of these options will be disclosed in more detail further below.

After the first input signal is received in step 101, the method comprises in step 102 comparing the parameter to a first criterion indicative of an allowed value or interval of the parameter. For each parameter that may be detected by a sensor 71, 72, 73, 74, 75 or received by the input device 70, there is thus an allowed value or an allowed interval. When checking 103, no correction is required at the present time if the first criterion is fulfilled, but if the first criterion is not fulfilled it is determined in step 104 that a pH correction of the liquid desiccant is needed.

Optionally, the steps above are repeated continuously or at predetermined intervals, or optionally when prompted by a user giving an input to the input device 70. By repeating the steps 101, 102, 103 and 104, the parameter is monitored and any need for correction to the pH of the liquid desiccant is determined iteratively. By determining when correction is needed, adequate correction is enabled in manners described herein. Further below, examples will be given for each of the parameters that may be received by the processing circuitry 5, and also examples for the first criterion and the liquid desiccant and the pH adjustment substance.

According to a first method embodiment, in optional step 105 a first control signal is generated based on the determined pH correction. The first control signal is suitably indicative of an amount of adjustment substance to be supplied to the liquid desiccant to achieve the determined pH correction based on the determined pH correction of step 104, and in optional step 106 the first control signal is transmitted to the pH adjustment unit 4. In other words, step 106 may be described as receiving the first control signal in the pH adjustment unit 4, from the processing circuitry 5 or the device in which it is comprised, e.g. the controller 50. In optional step 107, pH adjustment substance is supplied by the pH adjustment unit 4 to the liquid desiccant in the liquid desiccant container 2 or in the loop 61 in response to the first control signal. Suitably, the first control signal causes the controlled release mechanism 43 to allow a suitable amount of the pH adjustment substance to be supplied from the container 42 to the liquid desiccant. This may take place by a valve of the controlled release mechanism 43 opening for a suitable length of time or by a suitable amount of the pH adjustment substance being held in a smaller container of the pH adjustment unit 4 being released by the controlled release mechanism 43 by through an opening that is open until the smaller container is emptied. Other ways of releasing an amount of pH adjustment substance are also possible within the scope of the present invention. In some embodiments, a pre-determined amount of the pH adjustment substance may be used each time a correction is needed, but in other embodiments the optional step 105 instead comprises determining the amount of adjustment substance to be supplied as mentioned above.

Optionally, the method including the steps 101, 102, 103 and 104 as well as the optional steps 105, 106 and 107 are repeated in order to monitor the parameter, determine when the first criterion is no longer fulfilled, and optionally adjust pH of the liquid desiccant when the first criterion is no longer fulfilled.

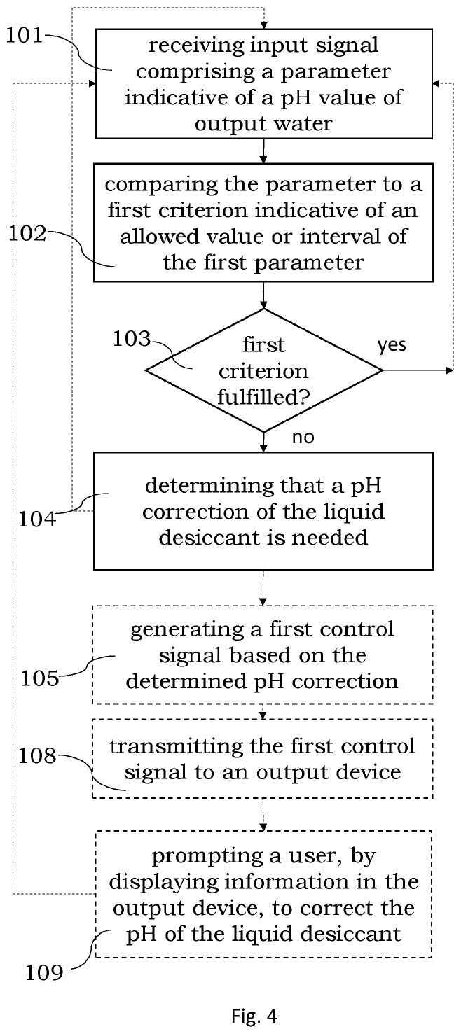

FIG. 4 discloses the steps 101, 102, 103, 104 of the method of the invention and also discloses optional step 105 where the first control signal is generated based on the determined pH correction of step 104. In optional step 108, the first control signal is transmitted to the output device 9. In other words, step 108 may be described as receiving the first control signal in the output device 9, from the processing circuitry 5 or the device in which it is comprised, e.g. the controller 50. Optional step 109 comprises prompting a user to correct the pH of the liquid desiccant by displaying or otherwise conveying information using the output device 9. The information displayed may be text on a screen of the output device 9 or information in the form of a light or a sound to prompt the user to act. The pH correction then takes place by the user entering the pH adjustment substance manually through the scalable opening of the pH adjustment unit 4′ on the liquid desiccant container 2 in response to being prompted by the device 10, via the output device 9. In some embodiments, the information conveyed using the output device 9 may indicate an amount of the pH adjustment substance to be supplied to the liquid desiccant, but in other embodiments a pre-determined amount may be used each time a correction is needed.

The steps 101, 102, 103, 104 may be repeated as described above, and optional steps 105, 108, 109 may also be repeated to enable monitoring of the parameter and enable determination of correction and optionally correction according to embodiments presented herein.

In both the first and the second method embodiments, the parameter may be detected by a sensor 71, 72, 73, 74, 75 and be transmitted to the processing circuitry 5.

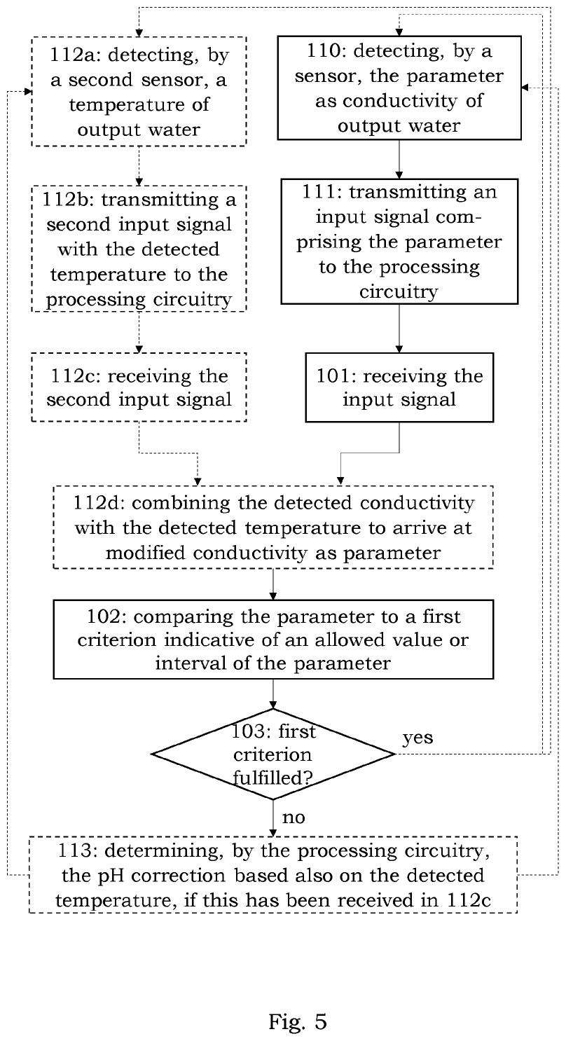

FIG. 5 discloses a third method embodiment that comprises optional steps 110, 111 and 113, and possibly also 112a, 112b, 112c and 112d, as described below. Step 110 comprises detecting, by a sensor 71, the parameter as a conductivity of the output water. In optional step 111 the first input signal comprising the parameter is transmitted to the processing circuitry and is then received 101 and compared 102 to the first criterion to check 103 if the first criterion is fulfilled, as described above.

In order to improve pH correction where the first criterion is not fulfilled, a second sensor 72 may be used to detect a temperature of the output water in optional step 112a. In this case, the method further comprises step 112b of transmitting an first input signal comprising or indicative of the detected temperature to the processing circuitry 5, receiving this first input signal in the processing circuitry 5, and is transmitted 112c to the processing circuitry. The detected conductivity may in this embodiment be combined 112d with the detected temperature to arrive at a modified conductivity as the parameter before comparing in step 102 with the first criterion to check 103 if the first criterion is fulfilled. The pH correction is then determined in optional step 113 based also on the detected temperature. This is advantageous since the conductivity is dependent on temperature so that the modified conductivity is a more accurate parameter than the detected conductivity when the temperature is not taken into account. However, in some embodiments the output water may be held at a predetermined temperature and the first criterion may be determined to take the known temperature into account. Thus, in some embodiment the detected conductivity may be sufficient to perform the method, meaning that the method in FIG. 5 may continue from step 103 to step 113, or to step 104 as described in any of the embodiments in connection with FIG. 3 or 4.

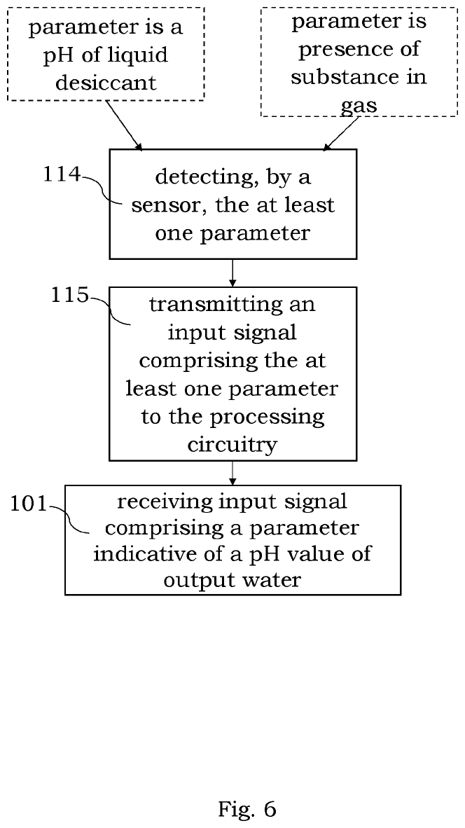

FIG. 6 discloses optional embodiments where the parameter is detected, measured or received in different ways, and these alternatives may be used separately or in combination with each other. Thus, in optional step 114 a sensor 73, 74 may detect the parameter, or detect or measure a value of the parameter. This may be done by a sensor 73 configured to detect a substance in the gas flow after passing through the water absorption unit 1. Alternatively, the sensor may be a pH sensor 74 arranged in connection with a pH measuring device 8 where liquid desiccant from the loop 61 may be entered and optionally diluted before the pH value being measured by the pH sensor 74. In some embodiments, the pH measuring device 8 may instead be arranged in connection with the liquid desiccant container 2.

When the at least one sensor 73, 74 has detected the parameter in optional step 114, an first input signal comprising the parameter is transmitted to the processing circuitry 5 in optional step 115 where it is received in step 101 so that the other method steps 102, 103, 104 may take place as described above.

In any of the embodiments described herein, the parameter may alternatively to being received from at least one sensor be received as manual input from the input device 70 in response to a user interacting with the input device 70.

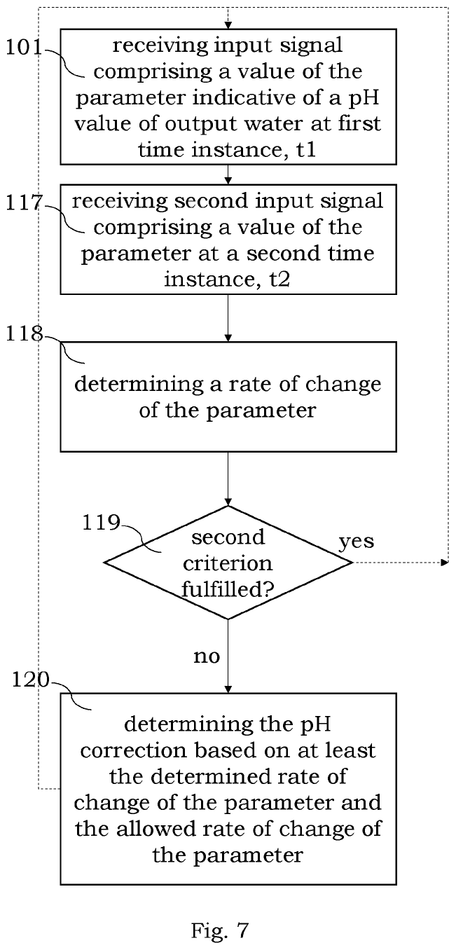

A fourth, optional, method embodiment is disclosed in FIG. 7 where a rate of change of the value of the parameter is determined and further pH correction may take place depending on whether the rate of change fulfils a second criterion. In the fourth method embodiment, the first input signal is received in step 101 and the value of the parameter is derived and is taken to denote the value of the parameter obtained at a first time instance t1. In optional step 117, a second input signal is received and the value of the parameter is derived and is taken to denote the value of the parameter obtained at a second time instance t2. The second time instance t2 differs from the first time instance t1. Based on the first input signal and the second input signal, a rate of change of the value of the parameter is determined in step 118 and the method then comprises checking 119 whether a second criterion for an allowed rate of change of the value of the parameter is fulfilled. If not, the required pH correction is determined in optional step 120 based on at least the determined rate of change of the parameter and the allowed rate of change of the parameter. Optionally, the steps of the fourth method embodiment may then be repeatedly performed. Obtained may in this context mean measured, detected, received or retrieved.

According to the fourth method embodiment, if the first criterion is fulfilled and the second criterion is not fulfilled, the pH correction may be determined based on at least the determined rate of change of the parameter and the allowed rate of change of the parameter. If the first criterion is not fulfilled and the second criterion is also not fulfilled, the pH correction may be determined based on at least the comparison of step ii), the determined rate of change of the parameter and the allowed rate of change of the parameter.

In some embodiments, a plurality of first input signals comprising the parameter at a plurality of time instances may be used to more accurately determine the rate of change of the value of the parameter. The fourth method embodiment may be performed by the processing circuitry 5 simultaneous to the method according to any of the embodiments described herein where checking the parameter against the first criterion and correcting the pH of the liquid desiccant takes place to maintain the pH of the liquid desiccant at a desired level or within a desired range. By also using the second criterion to determine whether the rate of change of the parameter is within an allowed range, the pH of the liquid desiccant is corrected in situations where the rate of change of the parameter indicates that the pH of the liquid desiccant is changing towards an undesired level or range. Thereby, the pH correction may take place even before the parameter fails to fulfil the first criterion.

Although embodiments of the invention described above with reference to the various embodiments, and processes performed in at least one processing circuitry, the invention also extends to computer programs, particularly computer programs on or in a carrier, adapted for putting the invention into practice. The programs may be in the form of source code, object code, a code intermediate source and object code such as in partially compiled form, comprise software or firmware, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

### EXAMPLES

Examples of the invention will now be given and some background of the need for correcting the pH of the liquid desiccant will be explained.

In devices 10 according to the present invention, a medium or substance is used as the liquid desiccant and acts to absorb water from the gas flow as described above. However, during use it may also occur that other substances from the gas flow are able to mix with the liquid desiccant and remain with the liquid desiccant as it is transported around the device 10. One such substance is carbon dioxide, CO2, that may react with the liquid desiccant such that other chemical compounds, typically acids, may be formed. This causes undesired effects such as a decrease in efficiency of water absorption, since the volume of liquid desiccant in the device 10 decreases when such other chemical compounds are formed. It may also cause the chemical compounds to be mixed in the water at regeneration and therefore be present as a contaminant in the output water, thereby decreasing quality of the water and possibly even rendering it unsuitable for use as drinking water. Furthermore, chemical compounds may be released into the gas flow in the water absorption unit 1 and be present in the gas downstream of the water absorption unit 1 and possibly cause undesired odors in the vicinity of the device 10.

Typically, the chemical compounds formed are acids and therefore lower the pH of the liquid desiccant and also of the output water and gas flow downstream of the device 10. By adding the pH adjustment substance to the liquid desiccant, the pH is elevated and the acidic compounds are no longer able to form. This resolves the problem of decreased efficiency of water absorption and also prevents acidic compounds from being released into the output water or the gas flow.

In some embodiments, the detected parameter is the conductivity in output water inside the liquid desiccant regeneration unit 3 or in the output water itself. The conductivity of water is well-known so any change in an expected conductivity indicates the presence of additional substances in the water. As mentioned above, it is advantageous in some embodiments to provide an additional sensor 72 for measuring the temperature of the water as well and to combine the detected temperature with the detected conductivity to arrive at the modified conductivity and compare this with an allowed level or allowed interval of conductivity. In other embodiments, the output water may be held at a known temperature or the variation of conductivity with temperature may be considered small enough that the detected conductivity may be compared directly with the allowed conductivity.

Thus, when the parameter is the conductivity of output water, the first criterion may be a threshold value so that the first criterion is fulfilled when the conductivity is above the threshold value or alternatively below the threshold value. In other embodiments, the first criterion may instead be an interval that is considered allowable so that the first criterion is fulfilled when the detected conductivity is within that interval. In one exemplary embodiment, the threshold value may be 55 mS/cm, or more suitably 50 mS/cm, and pH correction is then deemed as needed when the detected or measured conductivity (optionally combined with detected temperature to arrive at the modified conductivity) reaches this threshold value.

When adjusting the pH of the liquid desiccant by adding the pH adjustment substance, the formation of acidic substances is prevented and the presence of such unwanted compounds in the output water can be minimized or even eliminated. This results in the detected conductivity of output water returning to a value or range that is allowed and thus signifies that the first criterion is fulfilled and that no further correction is needed at the present time.

In some embodiments, the parameter is instead the presence of a substance in the gas flow downstream of the water absorption unit 1. This may be an acidic compound that has been transferred from the liquid desiccant to the gas flow during contact of the liquid desiccant and the gas inside the water absorption unit 1. The sensor 73 may be a sensor configured to detect a substance such as an acid so that the detected parameter gives an indication of an amount or a concentration of the acid in the gas flow, or even just a binary signal that signifies either that the acid is present in the gas flow or that it is not present. The first criterion may be a threshold value for an allowed amount or concentration of the acid in the gas flow, or may alternatively be an interval for an allowed range. When the first criterion is not fulfilled, the correction applied to the liquid desiccant raises the pH so that the formation of acid is prevented. This results in decrease or even elimination of the transfer of acid from the liquid desiccant to the gas flow in the water absorbing unit 1. The presence of the substance in the gas flow is a parameter indicative of a pH value of the output water, since any substance that is transferred to the gas flow in the water absorbing unit 1 is also transferred to the output water in the liquid desiccant regeneration unit 3. Thus, the amount of acid or the presence of such a substance at all in the gas flow indicates that the pH value of the output water differs from that expected in uncontaminated water, and by correcting the pH value of the liquid desiccant the contaminating substance is removed from both the gas flow and the output water. When detecting an acid, suitable threshold values may be 25 μg m⁻³, 75 μg m⁻³, 150 μg m⁻³ or 200 μg m⁻³. Again, a lower threshold value may be selected in applications where a high quality of output water and/or a high efficiency of operation of the device are important, whereas a higher threshold value may be selected where it is deemed more important to avoid frequent corrections of the pH of the liquid desiccant, in particular where the correction itself could cause interruption of the operation or similar.

In yet other embodiments, the parameter is instead the pH of the liquid desiccant, measured or detected by allowing a small portion of the liquid desiccant into the pH measuring device 8 and detecting the pH value there. The first criterion is suitably a threshold value giving a lower limit for an allowed pH of the liquid desiccant but may in some embodiments alternatively be an interval indicating an allowed range. Again, since the presence of an undesired or contaminating substance in the liquid desiccant signifies that this substance is also transformed to the output water during regeneration, the pH value of the liquid desiccant is a parameter indicative of the pH value of the output water. By correcting the pH of the liquid desiccant, the formation of substances such as acids is largely or even completely prevented, resulting in a decrease or even elimination of contaminating substances in the output water. For liquid desiccant diluted to 10%, the threshold value may be 7.5, 8.5, or 9.5. Selecting the threshold value may take place depending on a desired operation of the device or a desired quality of output water, and also depending on the substance used as liquid desiccant.

In yet other embodiments, the parameter is instead the pH of the output water. The first criterion is suitably a threshold value but may in some cases instead be a desired range. When a threshold value is used, this may be a pH of 6.5, 5.5, or 4.5 and the threshold may be selected depending on a desired quality of the output water. Where the water is to be used for drinking, the threshold value may be 6.5 whereas water with an intended use for other household purposes or for agriculture may instead have a threshold of 5.5 or 4.5. Thus, when the detected or measured pH sinks to the threshold value, the pH correction of the liquid desiccant should take place.

Also, in some embodiments the parameter is given as manual input into the input device 70. The parameter may be detected by the user smelling an acid in the gas flow from the water absorbing unit 1 and entering this information as input into the input device 70. The first criterion may then be a threshold value or an interval where the user denotes if the acid seems to be faint or noticeable in the gas flow, and where the correction is deemed to be needed if the acid is noticeable or pronounced in the gas flow, or alternatively that the correction is needed however faintly the acid can be smelled if the aim is to eliminate the acid altogether from the liquid desiccant.

Other manual input may comprise a pH value of the output water measured or detected further away from the device, or alternatively other properties of the output water, the gas flow that has passed the absorption unit, or any other factors or properties of the device.

In some embodiments, the liquid desiccant used in the device 10 is potassium acetate (KCH₃CO₂). When reacting with carbon dioxide (CO₂) captured from the gas flow, potassium acetate may form acetic acid (CH₃COOH) that can be transferred to the output water during regeneration when the liquid desiccant is boiled. A suitable pH adjustment substance may be potassium hydroxide (KOH), sodium hydroxide (NaOH), lithium hydroxide (LiOH) or calcium hydroxide (Ca(OH)₂), among others.

In other embodiments, the liquid desiccant may instead be sodium acetate (NaCH₃COO). When reacting with carbon dioxide (CO₂) captured from the gas flow, sodium acetate may also form acetic acid (CH₃COOH) that can be transferred to the output water during regeneration. Suitable pH adjustment substances are, among others, potassium hydroxide (KOH), sodium hydroxide (NaOH), lithium hydroxide (LiOH) or calcium hydroxide (Ca(OH)₂).

Other suitable liquid desiccants include potassium formate (HCOOK) that when reacting with carbon dioxide may form formic acid (HCOOH). Suitable pH adjustment substances are, among others, potassium hydroxide (KOH), sodium hydroxide (NaOH), lithium hydroxide (LiOH) or calcium hydroxide (Ca(OH)₂).

It is to be noted that features from the various embodiments described herein may freely be combined. unless it is explicitly stated that such a combination would be unsuitable.

1. Device for absorbing water from a gas, comprising
a water absorption unit for absorbing water from a gas flow using a liquid desiccant,
a liquid desiccant container, and
a liquid desiccant regeneration unit,
wherein the water absorption unit and the liquid desiccant container are operatively connected in a loop such that liquid desiccant is able to flow from the liquid desiccant container to the water absorption unit and again to the liquid desiccant container,
the liquid desiccant regeneration unit is operatively connected to the liquid desiccant container or to the loop for removing and regenerating liquid desiccant and returning regenerated liquid desiccant to the liquid desiccant container or to the loop, the liquid desiccant regeneration unit further comprises a water outlet for output water removed from the liquid desiccant during regeneration, the device also comprises a pH adjustment unit that is operatively connected to the liquid desiccant container or to the loop for supplying a pH adjustment substance to the liquid desiccant, and
the device further comprises processing circuitry configured to:
i) receive a first input signal comprising a parameter indicative of a pH value of output water,
ii) comparing the parameter to a first criterion indicative of an allowed value or interval of the parameter, and
iii) if the first criterion is not fulfilled, determining that a pH correction of the liquid desiccant is needed based on at least the comparison of step ii).

2. Device according to claim 1, wherein the processing circuitry is configured to
generate, based on the determined pH correction, a first control signal indicative of an amount of adjustment substance to be supplied to the liquid desiccant to achieve the determined pH correction, and
optionally also causing the pH adjustment unit to supply the indicated amount of adjustment substance.

3. Device according to claim 1, wherein the pH adjustment unit is a container for holding the pH adjustment substance, said container being connected to the liquid desiccant container or to the loop so that a controlled amount of the pH adjustment substance can be supplied to the liquid desiccant.

4. Device according to claim 1, further comprising an output device, and wherein the processing circuitry is configured to
generate, based on the determined pH correction, a first control signal indicative of an amount of adjustment substance to be supplied to the liquid desiccant to achieve the determined pH correction, and
display information in the output device prompting a user to correct the pH of the liquid desiccant such that the determined PH correction is achieved.

5. Device according to claim 4, wherein the pH adjustment unit comprises a sealable opening in the liquid desiccant container or in the loop and the sealable opening is configured to receive the pH adjustment substance through manual input by a user.

6. Device according to claim 1, wherein the processing circuitry is configured to repeatedly perform steps i)-iii).

7. Device according to claim 1, further comprising an input device with a user interface for receiving an input comprising the parameter, wherein the input device is configured to transmit the first input signal to the processing circuitry.

8. Device according to claim 1, further comprising at least one sensor configured to detect the parameter.

9. Device according to claim 8, wherein the sensor is a conductivity sensor for detecting a conductivity of water in the liquid desiccant regeneration unit or in the output water.

10. Device according to claim 9, further comprising a temperature sensor configured to detect a temperature of water in the liquid desiccant regeneration unit or in the output water, and wherein the processing circuitry is further configured to determine the pH correction based also on the detected temperature.

11. Device according to claim 8, further comprising a pH measuring device that is operatively connected to the liquid desiccant container or to the loop for receiving a quantity of liquid desiccant, and wherein the sensor is configured to measure the parameter in the pH measuring device.

12. Device according to claim 8, wherein the at least one sensor is configured to detect a substance in the gas flow downstream of the water absorption unit.

13. Device according to claim 8, wherein the sensor is a pH sensor for detecting a pH of water in the liquid desiccant regeneration unit or in the output water.

14. Device according to claim 1, wherein the first criterion comprises a threshold value or an interval.

15. Device according to claim 1, wherein the first input signal comprises a value of the parameter obtained at a first time instance, t1, and wherein the processing circuitry is configured to
receive a second input signal comprising a value of the parameter obtained at a second time instance, t2, that differs from the first time instance, t1,
determine a rate of change of the value of the parameter based on at least the first input signal and the second input signal,
compare the rate of change of the value of the parameter to a second criterion indicative of an allowed rate of change of the parameter, and
if the first criterion is fulfilled and the second criterion is not fulfilled, determine the pH correction based on at least the determined rate of change of the parameter and the allowed rate of change of the parameter; or
if the first criterion is not fulfilled and the second criterion is not fulfilled, determine the pH correction based on at least the comparison of step ii), the determined rate of change of the parameter and the allowed rate of change of the parameter.

16. Computer implemented method for improving operation of a water absorbing device, the device comprising
a water absorption unit for absorbing water from a gas flow using a liquid desiccant,
a liquid desiccant container, and
a liquid desiccant regeneration unit,
wherein the water absorption unit and the liquid desiccant container are operatively connected in a loop such that liquid desiccant is able to flow from the liquid desiccant container to the water absorption unit and again to the liquid desiccant container,
the liquid desiccant regeneration unit is operatively connected to the liquid desiccant container or to the loop for removing and regenerating liquid desiccant and returning regenerated liquid desiccant to the liquid desiccant container or to the loop, and the liquid desiccant regeneration unit further comprising a water outlet for output water removed from the liquid desiccant during regeneration,
the device also comprises a pH adjustment unit that is operatively connected to the liquid desiccant container or to the loop for supplying a pH adjustment substance to the liquid desiccant,
the device further comprises processing circuitry, and
the method comprises the steps of:
i) receiving, in processing circuitry, a first input signal comprising a parameter indicative of a pH value of output water, ii) comparing, using the processing circuitry, the parameter to a first criterion indicative of an allowed value or interval of the parameter, and
iii) if the first criterion is not fulfilled, determining, using the processing circuitry, that a pH correction of the liquid desiccant is needed based on at least the comparison of step ii).

17. Method according to claim 16, further comprising
generating, based on the determined pH correction, a first control signal indicative of an amount of adjustment substance to be supplied to the liquid desiccant to achieve the determined pH correction, and
optionally also causing the pH adjustment unit to supply the indicated amount of adjustment substance to the liquid desiccant.

18. Method according to claim 16, further comprising
generating, using the processing circuitry, a first control signal based on the determined pH correction,
transmitting the first control signal to an output device, and
prompting a user, by displaying information in the output device, to correct the PH value of the liquid desiccant such that the determined PH correction is achieved.

19. Method according to claim 16, comprising repeating steps i)-iii).

20. Method according to claim 16, further comprising
detecting, by a sensor, the at least one parameter, and
transmitting an first input signal comprising the at least one parameter to the processing circuitry.

21. Method according to claim 20, wherein the parameter is a conductivity of water in the liquid desiccant regeneration unit or of the output water.

22. Method according to claim 21, further comprising
detecting, by a second sensor, a temperature of the water, and
determining, by the processing circuitry, the pH correction based also on the detected temperature.

23. Method according to claim 20, wherein the parameter is a pH of the liquid desiccant.

24. Method according to claim 20, wherein the parameter is a presence of a substance in the gas flow downstream of the water absorption unit.

25. Method according to claim 20, wherein the parameter is a pH of the output water.

26. Method according to claim 16, further comprising receiving the parameter as manual input in an input device comprising a user interface.

27. Method according to claim 16, wherein the first criterion comprises a threshold value or an interval.

28. Method according to claim 16, wherein the first input signal comprises a value of the parameter obtained at a first time instance, t1, and wherein the method comprises
receiving, in the processing circuitry, a second input signal comprising a value of the parameter obtained at a second time instance, t2, that differs from the first time instance, t1,
determining, using the processing circuitry, a rate of change of the value of the parameter based on at least the first input signal and the second input signal,
comparing, using the processing circuitry, the rate of change of the value of the parameter to a second criterion indicative of an allowed rate of change of the parameter, and
if the first criterion is fulfilled and the second criterion is not fulfilled, determine the pH correction based on at least the determined rate of change of the parameter and the allowed rate of change of the parameter; or
if the first criterion is not fulfilled and the second criterion is not fulfilled, determine the pH correction based on at least the comparison of step ii), the determined rate of change of the parameter and the allowed rate of change of the parameter.
